(19) United States
(12) Patent Application Publication
(10) Pub. No.: US 2004/0250285 A1
(43) Pub. Date: Dec. 9, 2004

(54) Communication system and method

(76) Inventors: Thomas E. Murphy, Atlanta, GA (US); P. Thomas Watson, Alpharetta, GA (US)

Correspondence Address: SCOTT P. ZIMMERMAN, PLLC, PO BOX 3822, CARY, NC, 27519, US

(21) Appl. No.: 10/026,704

(22) Filed: Dec. 27, 2001

(51) Int. Cl. H04N 7/18; H04N 7/173; H04N 7/16

(52) U.S. Cl. 725/75; 725/80; 725/131; 725/133; 725/153

(57) ABSTRACT

The present invention relates to a system and method for distributing information. The system can include one or more set top boxes that can function as normal set top boxes, but can also conduct two way communications with other set top boxes. Users can send text, audio, and/or video messages to other users. The set top boxes can include provisions that permit two way communications, using video cameras, microphones and other inputs that can receive keyboard or text information.

### BACKGROUND

1. Field of the Invention

The present invention relates generally to a content distribution system, and more particularly, to content distribution system capable of providing two way communications.

2. Background of the Invention

Many dwellings and commercial establishments have installed media distribution systems to improve the reception of audio and video content. Often, these distribution systems take the form of either a cable television system or a satellite television system.

Currently, most systems provide one way communication. A signal source outside of the dwelling brings media content into the dwelling and this content is distributed throughout the dwelling. In many cases, the media content comprises programming for one or more television channels that are intended for various televisions disposed throughout the dwelling.

As the content is distributed, each of the televisions includes an associated tuner. In some cases, the tuner is built into the television or is in some way integral with the television, in other cases, a separate tuner is used. Separate tuners are often referred to as set top boxes.

Some dwellings include two way communication systems, generally in the form of intercom systems. Generally, these systems include at least two units that are permanently installed in a wall and hard wired to other units. These units generally permit only audio communications and require users to be in close proximity to the units to operate with the units and communicate using those units. They are generally inconvenient to use and provide limited usefulness.

### SUMMARY OF THE INVENTION

The present invention is directed to a system and method for using specially equipped set top boxes (referred to as “STBs”) and televisions to provide two way communications and to provide an intercom system within a dwelling. Message information can be provided to one STB and sent to second STB. The second STB receives the message information and sends that message information to an associated television. The message can be video, audio, and/or text.

In some cases, the second STB also includes provisions to collect message information and send that message information to the first STB. In this way, two way communications are possible between two STBs. The STBs can be designed to function as normal STBs when two way communications are not occurring.

In one aspect, the invention includes a network for distributing content and for providing two way communications including a first STB adapted to receive broadcast signals. The first STB can send those broadcast signals to a television and can also conduct two way communications with a second STB. The second STB is also adapted to receive the broadcast signals and can send those broadcast signals to another television. In this aspect, the second STB can conduct two way communications with the first STB.

In another aspect, the invention includes a network for distributing content and providing two way communications including a first STB having a first output adapted to be received by a first television and a second output that is adapted to be received by a second STB. The first STB includes an input that is adapted to receive input information from a user. This input information is then sent to the second STB using the second output. The second STB has an input that is adapted to receive information from the first STB. After the second STB receives information from the first STB, the second STB can send information related to the information received to a second television.

In another aspect, the invention includes an STB including a first output adapted to be received by a television, a second output adapted to be received by a second STB, and an input adapted to receive message information from a user. The message information is then sent out of the second output.

Additional features and advantages of the invention will be set forth in the description which follows, and in part will be apparent from the description, or may be learned by practice of the invention. The objectives and advantages of the invention will be realized and attained by the structure and steps particularly pointed out in the written description, the claims and the drawings.

### BRIEF DESCRIPTION OF THE DRAWINGS

FIG. 1 is a schematic diagram of a preferred embodiment of a system according to the present invention.

FIG. 2 is schematic diagram of a preferred embodiment of a rear panel in accordance with the present invention.

FIG. 3 is an isometric view of a preferred embodiment of a set top box in accordance with the present invention.

FIG. 4 is a schematic diagram of a preferred embodiment of a text message format in accordance with the present invention.

FIG. 5 is a schematic diagram of a preferred embodiment of a text message format in accordance with the present invention.

FIG. 6 is a schematic diagram of a preferred embodiment of a text message format in accordance with the present invention.

FIG. 7 is a schematic diagram of a preferred embodiment of a text message format in accordance with the present invention.

FIG. 8 is a schematic diagram of a preferred embodiment of a video message format in accordance with the present invention.

FIG. 9 is a schematic diagram of a preferred embodiment of a video message format in accordance with the present invention.

### DETAILED DESCRIPTION OF THE INVENTION

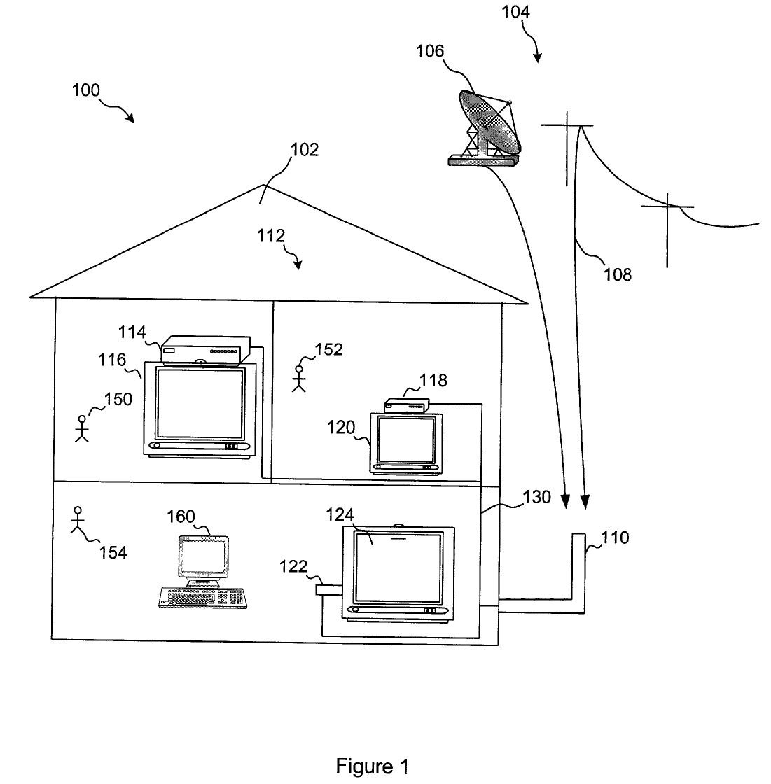

FIG. 1 shows a schematic diagram of a preferred embodiment of a network 100 in accordance with the present invention. A dwelling 102 includes a network 100. In this embodiment, the dwelling is a detached single family home, however, the dwelling could be any type of dwelling including apartments, condominiums, town houses and lofts. Dwelling can also refer to office buildings, warehouses, retail outlets, government buildings, military installations, schools, houses of worship, concert halls, stadiums, sports arenas, bars, clubs, or any other structure intended for temporary or permanent occupation by humans.

Network 100 includes an external signal source 104. External signal source 104 can be either a satellite dish 106 designed to receive satellite broadcasts or a cable 108 designed to receive a wire line transmission, for example, cable or fiber optic. External signal source 104 could also be some other form of content delivery. External signal source 104 is eventually placed in communication with external line 110. External line 110 places an internal network 112 in communication with external signal source 104.

Internal network 112 includes a first set top box 114 (referred to as “STB”) in communication with a first television 116, a second STB 118 in communication with a second television 120, and a third STB 122 in communication with a third television 124. Although this embodiment shows three STBs, more STBs or less STBs could be used. While the embodiment shown in FIG. 1 shows STBs 114, 118 and 122 as physically separate units from their associated televisions, it is possible to integrate an STB with a television. In such integrated units, the STB can be built into the television.

All of the various STBs are preferably in communication with external line 110. In the embodiment shown in FIG. 1, a wiring system 130 is preferably used to permit communications between external line 110 and the various STBs. As a signal is received by external line 110, the signal is distributed to the various STBs 114, 118 and 122 by wiring system 130. In this way, all of the STBs 114, 118 and 122 receive the signal received by external line 110.

One, several, or all of the STBs are preferably capable of communicating with other STBs. STBs can communicate with one another and with a service provider by the use of a back channel.

The term back channel generally refers to a communication path that is different than the programming content that is delivered by wiring system 130. There are many different ways to provide a back channel. In one embodiment, regular in-house telephone lines are used, in another embodiment, an Ethernet network connecting the various STBs with a switch/hub is used, in another embodiment, wiring system 130 is used. In some cases, back channel communications are established through the service provider.

Back channel communications that include higher bandwidth methods would generally be Ethernet (10BaseT, 100BaseT, 1000BaseT, etc.), HomePNA (1.0, 2.0 or higher), HomePlug (1.0 or higher) or 802.11b (or better) within the dwelling. All of the Ethernet methods would be supported on Category 5, 6, and/or 7 wiring and are generally wired point to point and to an Ethernet switch/hub, Home Gateway, or Home Media server.

HomePNA 1.0 and 2.0 are supported on regular in-house phone wiring and their maximum bit rates dependent on the quality of the in-house wiring. Generally, HomePNA can support about 10 Mbps. HomePlug is supported by in-house power wiring. HomePlug is capable of transmitting at about 1 Mbps reliably and as high as 10 Mbps, although the specification calls for 14 Mbps in some reports. 802.11× supports wireless communication in the 1 to 10 Mbps range for now.

Other high-speed back channel communications options include Cable Modem and xDSL. With these modes of communications, messages could be sent back to a service provider and messages could also be relayed between STBs. These communication methods vary in bandwidth from 1.4 Mbps (ADSL-DMT) to 10 Gigabits per second for 10 GBaseT.

From a design standpoint, any bit rate over 700 Kbps can practically handle video communication (depending on video resolution and picture size) and communication mode over 300 Bps can support text messaging. Bit rates of greater than 2 Mbps can display full screen video on existing televisions and STB technology. Once the desired back channel communications are selected, a suitable communication mode for the back channel is chosen from the various options discussed above. Also, once a communications mode is chosen, provisions, for example, suitable connectors and/or cables, are provided on appropriate STBs.

For example, if only text messaging is desired for back channel communications, then any communication mode, including dial-up modem, could be selected for the STBs. However, if high quality video messaging is desired, then a higher speed communication mode, for example, Ethernet, would be selected for the STBs.

Preferably, IP addressing will be used to address specific STBs. IP addressing could be combined with TCP or UDP messages. Various existing methods of discovery can be used to find other STBs on the network. Manual methods might be advantageous for privacy concerns for networks behind a firewall.

This network permits users to both receive content from an external source and to send messages to one another using STBs. In other words, STBs are used to receive content and send an appropriate signal to an associated television, and in addition, include provisions that permit users to send messages or communicate with other STBs. These messages can include text, audio, and/or video. Because users can send and receive messages, the network provides two way communications using STBs. The network can be thought of as an intercom system with much more flexibility and with many more features and capabilities.

There are many possible uses for STBs that provide two way communications. In one example, the STBs can be used to provide an audio, video and/or text intercom system. Returning to FIG. 1, consider an example where a first user 150 wants to communicate with a second user 152. In this example, both users 150 and 152 are in proximity to a respective STB that includes provisions that permit two way communications.

In order to communicate with second user 152, first user 150 would first create a message for second user 152. The message could include a text component, an audio component, a video component, or a combination of components. The message could be created and sent to second user 152 or the message could be retrieved and sent to user 152. In the case where the message is retrieved and then sent, the original message is created some time before the time the message is sent and stored. The message is then later retrieved and sent.

Text messages can be created in many different ways. First user 150 could type the message using a keyboard, wireless remote control or first STB 114 could receive a voice input from first user 150 via one or more of the microphone inputs 218, 220 and/or 222 and STB 114 could use voice recognition technology to convert the voice input to text. Text messages can be sent soon after creation or can be stored for later retrieval and transmission. STB 114 can also include a number of pre-made text messages that are commonly used.

In addition, messages can be created by using a personal computer 160 connected to the same in-house network. Custom interface software for the STB can be provided and the subscriber can create and store messages on the STB. Pre-made messages can be prepackaged in the software or in the STB. Some examples of prepackaged messages include “Dinner is Ready,” “Telephone Call for You,” “Have you finished your homework?” or “Will the owner of the vehicle with Tag # xxxxxx, please see the manager immediately!”

The text message can also include information related to incoming messages. In one embodiment, a “new message waiting” indicator, icon or notification can be provided. Users can choose to view or ignore the detailed information. The “new message waiting” indicator could also be audible, for example, announcing “you've got mail!” or some other similar message.

Messages can be updated by the service provider either by private data in the MPEG transport stream or through update messages from service provider via back channel communications. In addition, messages can be downloaded from the Internet.

First user 150 can create voice messages. First STB 114 can receive a voice input from first user 150 via one or more of the microphone inputs 218, 220 and/or 222. STB 114 can either store or send the voice message as directed by first user 150. STB 114 can also include a number of pre-made voice messages that are commonly used.

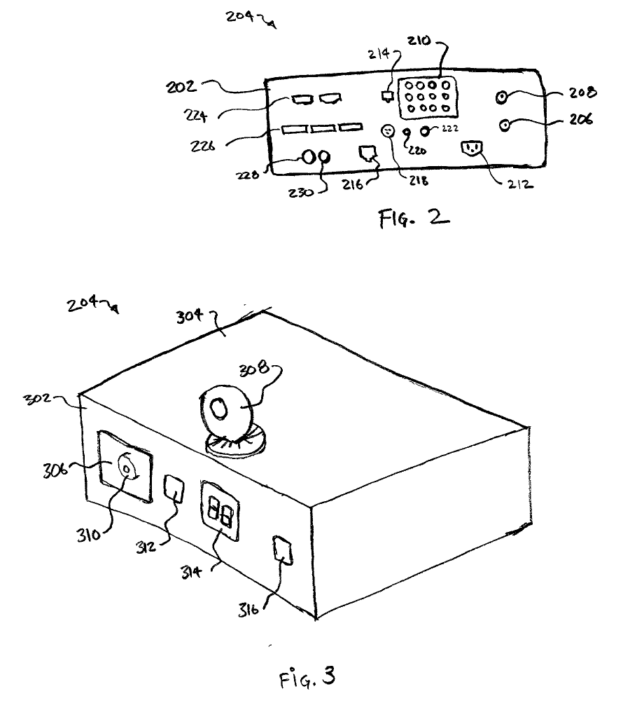

Video messages can be made and either stored or sent by first STB 114. Video messages can be created using one of the video cameras, either internal video camera 310 (see FIG. 3) or external video camera 308 (see FIG. 3). Like other forms of messages, video messages can be stored or sent. In addition, other video messages, video clips or movies can be transferred to STB 114 via Firewire connector 224 or USB or serial connector 226. These video messages can then be sent to other STBs.

Again, it is possible to combine the various forms of messages. For example, a single message can include a text component, an audio component and/or a video component.

Once a desired message has been created or retrieved, first user 150 can send the message to second user 152 or to third user 154. In this example, first user 150 intends to send the message to second user 152. Preferably, first STB 114 includes a command that sends the message to second user. Preferably, the command includes instructions that direct first STB 114 to send the message only to the appropriate STBs. Preferably, each STB 114, 118 and 122 includes an address. In the example shown in FIG. 1, an IP (Internet Protocol) address is used. So, first STB 114, when sending the message, includes the appropriate IP address to facilitate delivery of the message to second STB 118. The message can be sent to more than one STB or to every STB within the dwelling.

The system provides formatting features for all of the various forms of messages. Formatting can be pre-set and fixed, meaning that users cannot change the formatting conditions of the messages. Message formats can include default conditions that provide pre-defined message formats where users do not define a message format, but can be altered if the user defines a different message format. Or the messages can be purely user definable, where there is no default format and the user must define a message format. The system can also present several message format options that the user can select. Some of the message format options can be user defined.

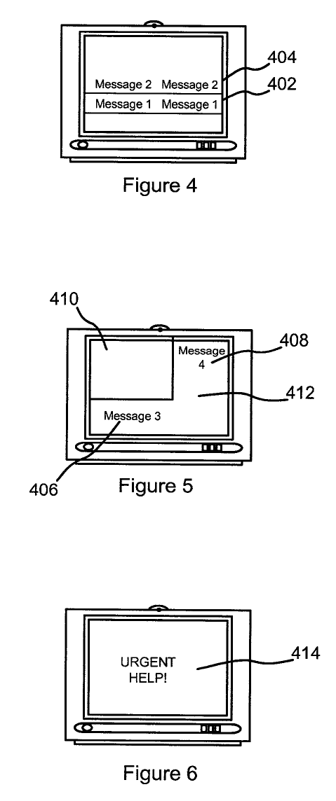

To continue with the current example, where first user 150 uses first STB 114 to send a message to second user 152 using second STB 118, various different formats can be used to display the text message. Referring to FIG. 4, which shows the image displayed on second television 120, a first text message format 402, includes a background color and a contrasting foreground color for the text. Second text message format 404 does not include a background color but does provide brightly colored foreground text. To display these messages, second STB 120 receives text information along with formatting information from first STB 114. After receiving and interpreting the information, second STB 118 modifies the video signal that is being sent to second television 120 so that the text message is appropriately displayed.

In FIG. 5, the displayed image 410 is reduced leaving blank margin 412 below displayed image 410 and beside displayed image 410. Text can be placed within blank margin 412. In one embodiment, a third text message format 406 is placed in the horizontal portion of blank margin 412 and in another embodiment, a fourth text message format 408 provides text in the vertical portion of blank margin 412.

In another embodiment, shown in FIG. 6, a fifth text message format 414 replaces the displayed image with a blank, solid or patterned background and prominently displays a text message. This format can be used for urgent messages.

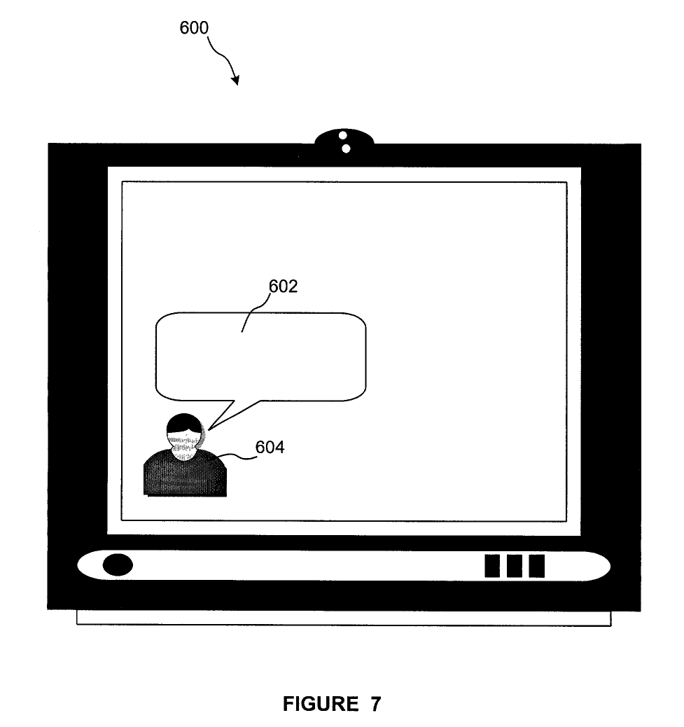

In another embodiment shown in FIG. 7, a sixth text message format 600 places the text in a callout bubble 602. In some embodiments, a picture, drawing or representation 604 of the party sending the message is shown on the screen along with callout bubble 602. In other embodiments, picture, drawing or representation 604 is omitted.

In all of these embodiments, the text can include various characteristics. The text can scroll and/or move, change size, change color, blink, and the font of the text can be selected.

Audio messages can also be formatted in a number of different ways. The audio message can replace the current audio being played so that only the audio message is heard. The audio message can be “voiced over” the current audio signal. This can be accomplished by either providing the audio message with a volume that is greater than the volume of the current audio signal or the audio message is played at a normal or preset volume while the current audio program is reduced by an amount significant enough to render the voice message audible and intelligible. Typically, the current audio signal can be reduced by 10 to 50 dB, for example, to provide this difference in volume. The audio message could also be sent to specific audio channels. For example, considering a stereo configuration, the audio message could be sent to the Left audio output and the current audio signal would remain active on the Right audio output. Considering a 5.1 surround sound mix, the audio message could be sent to either or both the Front and/or Center channel speakers while the current audio program would continue to play on the Rear speakers and the LFE (Low Frequency Effects) channels. Any desired combination of these audio formats could be used.

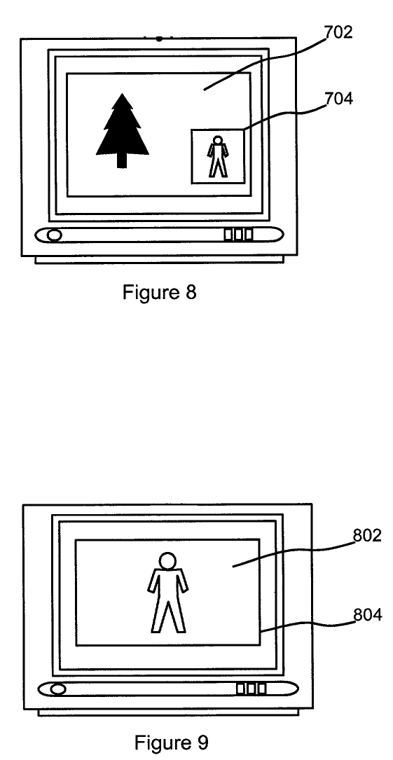

It is also possible to provide a variety of video message formats. FIG. 8 shows an embodiment where an underlying image 702 is displayed and a window 704 containing the video message is displayed over a portion of the underlying image 702. This video message format is similar to a picture-in-picture format. The size, shape and location of window 704 can be changed by either the sender of the message, in this example, first user 150, or by the recipient of the message, in this case, second user 152. In the embodiment shown in FIG. 9, the video message format is such that the video message 802 fills the entire screen 804. In both of these embodiments, the video message window preferably appears for the duration of the video message and then disappears after the video message has concluded.

Returning to FIG. 1, for purposes of clarity and simplicity, the above examples were limited to a situation where first user 150 used first STB 114 to send various messages to second user 152 using second STB 118. Obviously, first user 150 could have sent messages to third user 154 or to both second user 152 and third user 154. Clearly, second user 152 and third user 154 could also have sent various messages to other users as well.

FIGS. 2 and 3 show a preferred embodiment of an STB in accordance with the present invention. The particular types of input and output provisions preferably used in connection with the STBs is disclosed.

FIG. 2 is a schematic diagram of a preferred embodiment of a rear panel 202 of an STB 204. Rear panel 202 provides input and output connectors. Preferably, rear panel 202 provides a sufficient numbers and types of connectors to permit STB to communicate with a television, to receive input from users, to send output to other STBs and to provide back channel communications to a business office.

The various components, which are not drawn to scale include at least one F-type connector 206 adapted to receive content from wiring system 130 (see FIG. 1). Rear panel 202 can also include connectors to permit communication with a television. Another F-type connector 208 can provide audio and video signals to a television, and rear panel 202 can also include a number of RCA connectors 210 that provide multi-channel audio and composite video to a television or monitor. Preferably, there are enough RCA connectors to accommodate any desired multi-channel audio format including: mono, stereo, Dolby Surround™, Dolby Pro-Logic™, Dolby Pro-Logic II™, Dolby Digital™ (5.1), Dolby Digital EX™ (6.1), DTS™, DTS ES™, and 7.1 formats. Rear panel 202 can include an optical output 214 that can provide an optical digital bitstream for outboard decompression and decoding. Generally, this optical digital bitstream is used to send a multi-channel audio signal to a processor, pre-amplifier or receiver capable of decoding and decompressing the optical digital bitstream. An RCA, S-Video, optical or DVI (Digital Video Interface) connector can also be provided for the video signal as well. This would permit the use of outboard D to A converters for the video signal.

Rear panel 202 also includes a power connector 212 adapted to engage a power cord and deliver power to STB 204. Instead of a connector 212, a fixed cord could be provided instead.

A telephone connector 216 can be provided which would permit STB 204 to communicate. Generally, telephone connector 216 is in the form of an RJ-11 connector, although an RJ-45 connector could also be used, and is designed to provide subscription information to a business office.

STB 204 can include provisions to accept inputs from users. Audio inputs in the form of an XLR connector 218, an ⅛” connector 220, and/or a ¼” connector 222 can be provided. These inputs can be used to connect a microphone to STB 204.

One or more Firewire™ (IEEE 1394) connectors 224 can be provided. These Fireware connectors can be used to receive digital video, still video (for example, from a digital camera or scanner), and/or digital audio information. Additionally, one or more USB and/or serial ports 226 can be provided. These ports can be used to receive digital video, still video (for example, from a digital camera or scanner), digital audio, or data (for example from a remote control device, keyboard and/or a game controller). Other connectors, including Ethernet, 802.11×, and/or HPNA could be provided as well, if desired. STB 204 can also include a keyboard connector 228 and a mouse or pointing device connector 230.

FIG. 3 shows an isometric view of a preferred embodiment of STB 204. STB 204 includes a front panel 302 and a top 304. STB 204 can include an integral video camera 310 located inside STB 204 behind a window 306 and/or a mounted video camera 308 mounted on top panel 304. Either or both of these video cameras can be used to collect video information. Integral camera 310 is preferably connected to STB internally and mounted video camera can either be connected integrally or externally by using a Firewire connector 224 or a USB or serial connector 226.

Front panel 302 can also include an integrated microphone 312 that can be used to collect audio information. Front panel 302 includes a display 314 and an infrared sensor 316. The display 314 can be used to display information, for example, the current channel, and infrared sensor 316 is designed to receive infrared information from an IR keyboard or other IR device. This could be from a remote control device but infrared sensor 316 could also receive infrared data. STB 204 can also include a radio frequency receiver (not shown) that can receive radio frequency information, for example, radio frequency information formatted according to the Bluetooth™ and/or the 802.11× protocols.

The foregoing disclosure of the preferred embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A network comprising:
a first set top box having a first output adapted to be received by a first television and a second output adapted to be received by a second set top box; the first set top box further comprising an input adapted to receive input information from a user; and
the second set top box having a third output adapted to be received by a second television.

2. The network according to claim 1, wherein the input information comprises an audio and video information.

3. The network according to claim 1, wherein the input information comprises text.

4. The network according to claim 1, wherein the input information comprises pre-formatted messages.

5. The network according to claim 1, wherein the input information is retrieved from a memory device.

6. The network according to claim 1, wherein the second set top box receives the output information from the first set top box and wherein the second set top box sends second output information to the second television.

7. The network according to claim 6, wherein the second output information is displayed on a portion of the second television.

8. The network according to claim 1, wherein the second set top box sends second output information to the third output, wherein second output information is related to output information.

9. The network according to claim 8, wherein the second output information is formatted according to a preselected message format.

10. A network comprising:
a first set top box adapted to receive a broadcast signal, transmit a first television signal, and conduct two way communications with a second set top box; and
the second set top box adapted to receive the broadcast signal, transmit a second television signal, and conduct two way communications with the first set top box.

11. The network according to claim 10, wherein the second television signal is different than the first television signal.

12. The network according to claim 11, wherein the second television signal includes text.

13. The network according to claim 11, wherein the second television signal includes pre-formatted messages.

14. The network according to claim 11, wherein the second television signal includes information retrieved from a memory device.

15. The network according to claim 10, wherein the first set top box includes a video camera.

16. The network according to claim 10, wherein the first set top box includes a microphone.

17. The network according to claim 10, wherein the first set top box includes an input adapted to receive information from a keyboard.

18. The network according to claim 10, wherein the second set top box includes a video camera.

19. A set top box comprising:
a first output adapted to be received by a television;
a second output adapted to be received by a second set top box;
an input adapted to receive message information from a user; and
wherein the message information is sent out of the second output.

20. The set top box according to claim 19, wherein the message information includes audio information.

21. The set top box according to claim 19, wherein the message information includes video information.

22. The set top box according to claim 19, wherein the message information includes text information.

23. The set top box according to claim 19, wherein the message information includes a pre-formatted message.

24. The set top box according to claim 19, wherein the message information is retrieved from a memory device.

25. The set top box according to claim 19, further comprising a video camera.

26. The set top box according to claim 19, further comprising a microphone.

27. The set top box according to claim 19, further comprising an input adapted to receive information from a keyboard.

28. The set top box according to claim 19, further comprising an input adapted to receive information from a video camera.

29. The set top box according to claim 19, further comprising an input adapted to receive information from a microphone.
